(19) United States
(12) Patent Application Publication
(10) Pub. No.: US 2026/0211554 A1
(43) Pub. Date: Jul. 23, 2026

(54) HOST ACCESS MANAGEMENT IN A DISTRIBUTED STORAGE ARRAY

(71) Applicant: Dell Products L.P., Round Rock, TX (US)

(72) Inventors: Jeffrey Wilson, Franklin (MA); Scott Rowlands, Cumming, GA (US); Arieh Don, Newton, MA (US)

(73) Assignee: Dell Products L.P., Round Rock, TX (US)

(21) Appl. No.: 19/034,753

(22) Filed: Jan. 23, 2025

(51) Int. Cl. G06F 3/06

(52) U.S. Cl. CPC G06F 3/0611; G06F 3/0634; G06F 3/067

(57) ABSTRACT

Disclosed are methods, systems and computer readable media for managing host access in a distributed storage system. A first array and a second array are part of a distributed storage system in which each array is a remote data facility-duplicate array in an active-active configuration. Input/Output (I/O) requests are transmitted to each array. Response times from the I/O requests are determined at the arrays a priority is assigned to one of the first array and the second array based on a comparison of the response times.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

In a remote data facility (RDF) environment where a host device is cross-connected to two arrays which are in an active-active relationship, the host can send input/output requests (I/Os) to both arrays in a round-robin fashion, as the host is not aware there are multiple arrays. From the host perspective, communication is carried out with a storage device having multiple paths, unaware that the storage device is located on two different arrays.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include providing a first array and a second array in a distributed storage system. One or more first I/O requests may be received to the first array from a host device. The first array may determine a first response time from the one or more first I/O requests. One or more second I/O requests may be received to the second array from the host device. The second array may determine a second response time from the one or more second I/O requests. A priority may be assigned to one of the first array and the second array based on a comparison of the first response time and the second response time.

According to another aspect, a system may include a memory and at least one processor that is operatively coupled to the memory. The at least one processor may be configured to perform the operations of providing a first array and a second array in a distributed storage system. One or more first I/O requests may be received to the first array from a host device. The first array may determine a first response time from the one or more first I/O requests. One or more second I/O requests may be received to the second array from the host device. The second array may determine a second response time from the one or more second I/O requests. A priority may be assigned to one of the first array and the second array based on a comparison of the first response time and the second response time.

According to another aspect, a non-transitory computer-readable medium may store one or more processor-executable instructions, which when executed by at least one processor cause the at least one processor to perform the operations of providing a first array and a second array in a distributed storage system. One or more first I/O requests may be received to the first array from a host device. The first array may determine a first response time from the one or more first I/O requests. One or more second I/O requests may be received to the second array from the host device. The second array may determine a second response time from the one or more second I/O requests. A priority may be assigned to one of the first array and the second array based on a comparison of the first response time and the second response time.

The method, system and computer-readable medium may further include, alone or in combination, one or more of the following features. The first and second arrays may be arranged in a remote data facility (RDF) configuration. The first and second arrays may be arranged in an active-active configuration. The priority may include an Asymmetric Logical Unit Access (ALUA) optimized state. The priority may include an ALUA non-optimized state. The first response time and the second response time may each comprise an average response time of the respective one or more first I/O requests and the one or more second I/O requests. The comparison may comprise selecting a lowest response time from the first response time and the second response time. The comparison may include determining the first response time and the second response time are substantially the same and assigning the priority may comprise balancing the priorities between the first array and the second array. The priority may be continuously updated based on subsequent response time measurements by the first array and the second array. The priority may be updated based on a monitoring device. The priority may be updated based on an imbalance in received I/O requests to one of the first array and the second array.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a system, according to aspects of the disclosure;

FIG. 1B is a diagram of an example of a storage system, according to aspects of the disclosure;

FIG. 2 is a diagram of an example of a port map, according to aspects of the disclosure;

FIG. 3 is a diagram of a port map portion, according to aspects of the disclosure;

FIG. 4 is a diagram illustrating an example of a system including a host system communicatively coupled to a data storage system via multiple I/O paths, according to aspects of the disclosure;

FIG. 5 is a diagram illustrating an example of a plurality of logical layers of a combination of a host system and a data storage system for processing an I/O request, according to aspects of the disclosure;

FIG. 6 is a flow diagram of a method of managing host access in a distributed storage system, according to aspects of the disclosure; and

FIG. 7 is a diagram of an example of a computing device, according to aspects of the disclosure.

### DETAILED DESCRIPTION

In networking, ALUA (Asymmetric Logical Unit Access) is a protocol used in storage area networks (SANs) to optimize how devices access storage. It is primarily used in environments with multiple storage controllers (often called storage processors), which can be found in redundant or high-availability storage systems. In general, ALUA enables the storage system to designate one or more controllers (i.e., storage processors or ports in the storage processor) as the “optimized” or active path, which may provide better performance and faster access. Other paths in the storage system may be labeled as non-optimized and used only when the optimized path is unavailable (due to failure, overuse, maintenance or the like). ALUA works with multipathing software, which may manage multiple paths between a host and one or more storage devices. The software may use ALUA to determine which path is preferred at any given time and can switch paths if a failure occurs, ensuring continuous access.

The present disclosure provides concepts, techniques and structures for enforcing host access to a specific array in a distributed storage array environment, in particular an active-active remote data facility (RDF) configuration, by controlling the array paths' ALUA states. The method can be used to enhance the existing ALUA specification, or it can be used independently. The concepts, techniques and structures permit the storage arrays to determine which array is closest to the host (e.g., experiences the lowest I/O request response time) and assigned that array a priority for handing I/O requests, for example an ALUA “optimized” or “non-optimized” state. In the context of ALUA, the priority status discussed herein may also be referred to as ALUA Asymmetric Access State (AAS).

When the priority status of a port is set to “optimized” with respect to a given logical unit number (LUN), that port may be given a preference for the transmission of I/O requests to the given LUN over ports whose priority status is “non-optimized”. In this regard, for example, the given host device will transmit I/O requests for a first LUN, (e.g., LUN 1) over port 1, unless port 1 is unavailable, in which case the given host device may resort to using port 2.

The term “ALUA priority status” is used herein for ease of description. As noted above, the concepts, techniques and structures described herein involve assigning a LUN-specific priority status for each (or any) of the ports in a host device. The priority status of a particular port in a given host device, with respect to a particular LUN, may be set in the storage array port and detected by the host port to either an “optimized” value or a “non-optimized” value.

The storage systems described herein may be enterprise storage systems that are connected to different servers in a data center via a Fiber Channel (FC) network. In this regard, the given host device from the above example may be a server that is running one or more applications that use different LUNs in the storage system for their data storage needs. According to one aspect, each of the ports in the host device may have a different worldwide name (WWN). Different ports in the host device may present themselves to the storage system through their WWNs. However, because the storage system is connected to multiple host devices, in a conventional setting, the storage system would be unaware of which ports belong to the same host device. In other words, a conventional storage system would see a plurality WWNs that belong to different ports, but it would lack awareness of which ports belong to the same host device.

Unlike conventional storage systems, the storage system described herein may be configured to identify all (or at least some) ports through which a given host device is connected to the storage system. After which, the storage system may set the priority status of one of the ports to “optimized” while setting the priority status of the rest of the identified ports to “non-optimized”.

In some respects, each port of a given host device may be mapped by the FC network to a corresponding port in the storage system. The mapping may be performed by the switches and other equipment which constitutes the FC network connecting the given host device to the storage system. The 2-tupple consisting of a host port and a storage system port can also be referred to as a “communications path” that connects the host device to the storage system. As is discussed further below, the LUN-specific priority status of a host device port may apply to a particular network path originating at the host device port and ending at a specific storage array port, such that there can be multiple LUN-specific priority assignments for different network paths originating from the host device port and terminating at different storage array ports.

As is discussed further below, by setting a LUN-specific status of each (or at least one) of the ports, on each (or at least one) of the host devices that are connected to the storage system, the storage system may effectively manage (e.g., enforce) host access to one of an active-active RDF array pair among the various LUNs. As can be readily appreciated, enforcing a host access to a particular array or LUN may help, among other advantages improve the latency (or efficiency) at which the storage system fulfills I/O requests. Accordingly, the concepts, techniques and structures for managing host access to a LUN, which is disclosed herein, is advantageous because it can improve the operation of storage systems.

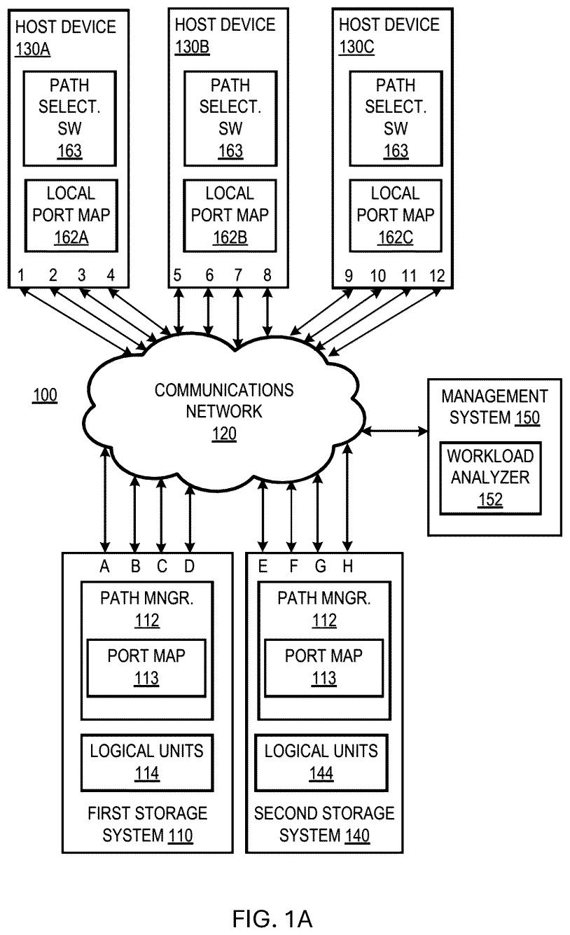

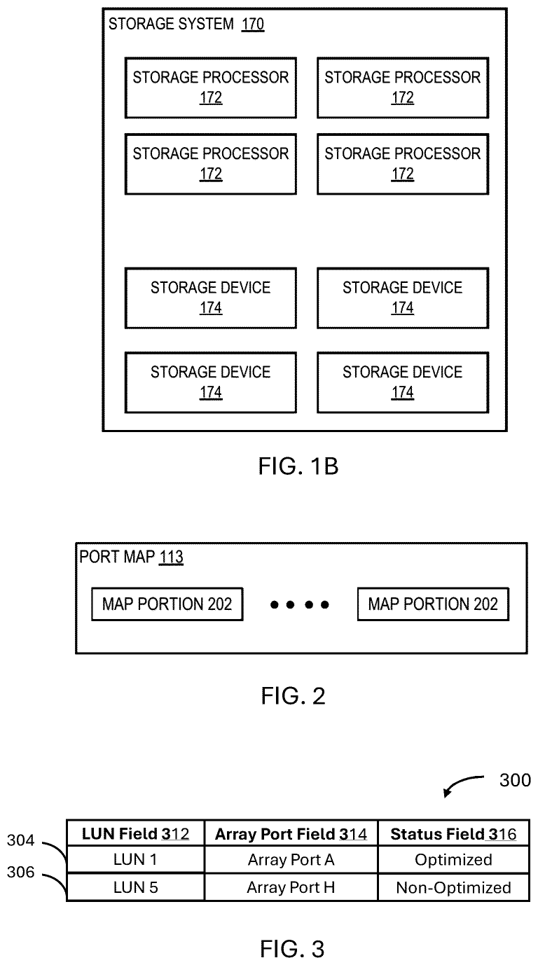

In some implementations, the LUN-specific status to individual ports assigned by the storage array and detected by the host may be performed by an external tool or other software. The external tool (e.g., workload analyzer (WLA) 152, shown in FIG. 1A) or other software may be executed on a management console (e.g., management system 150, shown in FIG. 1A) that is part of the storage system and/or any other computing device that is part of the storage system. In some implementations, to perform the LUN-specific assignment, the management console may leverage the Fabric Device Management Interface (FDMI) protocol that is implemented in the switches of the FC network connecting host devices to the storage system. The FDMI protocol may provide detailed information about Host Bust Adapter (HBA), including vendor information, the model, or the firmware version of the host device. Importantly, for each HBA, the FDMI protocol may also provide the hostname of the host device of which the HBA is part. Furthermore, for each port in an HBA, the FDMI protocol may provide the WWNs of the host devices. Stated succinctly, the capabilities afforded by the HBA protocol enable the external tool to discover all ports that connect a given host device to the storage network by querying the FDMI interface of one or more switches in the FC network and processing the returned information to cross-reference port WWN's with the host device names that belong to the host devices of which the port's HBA is part.

As used herein, the terms “LUN” and “logical unit (LU) are used interchangeably. In general, LUs in a storage system are referenced by their LUNs and for this reason, the terms are used interchangeably. An LU in a storage system may be a data volume and/or any other suitable type of virtualized representation of storage.

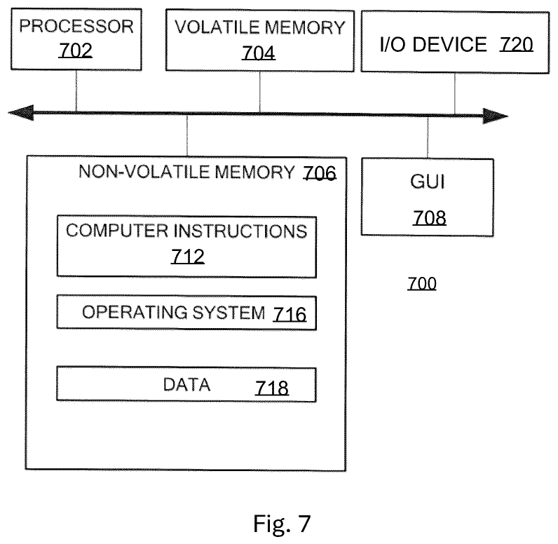

FIG. 1A is a diagram of an example of a system 100, according to aspects of the disclosure. As illustrated, system 100 may include storage systems 110 and 140 that are coupled to a plurality of host devices 130A-C and a management system 150 via a communications network 120. According to the present example, each of the host devices 130A-C is a server that is configured to access the storage system 110 and/or storage system 140 for its data storage needs. Additionally, or alternatively, in some implementations, each of the host devices 130A-C may be the same or similar to the computing device 700, which is discussed further below with respect to FIG. 7. Management system 150 may include any suitable type of computing device that is arranged to manage one or more aspects of the operation of at least one of storage systems 110 and 140. Management system 150 may be the same or similar to the computing device 700, which is discussed further below with respect to FIG. 7. Storage system 110 may include any suitable type of storage system. In one example, storage system 110 may be the same or similar to storage system 170, which is discussed further below with respect to FIG. 1B. Storage system 140 may include any suitable type of storage system. In one example, storage system 140 may be the same or similar to storage system 170, which is discussed further below with respect to FIG. 1B.

FIG. 1B is a diagram of an example of a storage system 170, according to aspects of the disclosure. As illustrated, the storage system 170 may include a plurality of storage processors 172 and a plurality of storage devices 174. Each of the storage devices 174 may include a hard disk (HD), a solid-state drive (SSD), a non-volatile random-access memory (NVRAM) device, a non-volatile memory express (NVME) device, and/or any other suitable type of storage devices. Each of the storage processors 172 may include a computing device, such as the computing device 700, which is discussed further below with respect to FIG. 7. Each of the storage processors 172 may be configured to execute I/O requests that are received at storage system 170 from computing devices 130A-C by reading or writing data to the storage devices 174.

Returning to FIG. 1A, storage system 110 may include a plurality of logical units (LUs) 114, and storage system 140 may include a plurality of LUs 144. Each of LUs 144 may be a copy of a different one of LUs 114. In one example, storage systems 110 and 140 may be configured to operate in an active-active or active-passive configuration. When storage systems 110 and 140 operate in active-active configuration, each of host devices 130A-C is permitted to write to either one of the storage systems 110 and 140 (and one or more respective LUs 114, 144), after which the write is propagated to the other one of storage systems 110 and 140 before the write is acknowledged. Although, in the present example, system 100 includes both storage systems 110 and 140, in an alternative implementation, system 100 may include only one of the storage systems 110 and 140.

Storage systems 110 and 140 may include a plurality of ports, which are enumerated in FIG. 1A as ports A-H, wherein ports A-D are part of storage system 110 and ports E-H are part of storage system 140. Although, in the present example, storage systems 110 and 140 include four ports each, it will be appreciated that in many practical applications, a storage system may have a much larger number of ports. Each port may be a port that is provided by an HBA in one of the storage processors in storage system 110 or storage system 140. Each of storage systems 110 and 140 may be configured to execute a respective instance of a path manager 112. According to the present example, the path manager is an ALUA module (or “ALUA controller”). However, alternative implementations are possible in which path manager 112 is any software that is configured to assist the host devices 130A-C, and or communications network 120, in their path selection activities.

As used throughout the disclosure, the terms “storage system” and “storage array” are used interchangeably. Under the nomenclature of the present disclosure, each of the ports A-H is also referred to as “an array port”. Under the nomenclature of the present disclosure, each of the ports 1-12 is also referred to as “a host port”.

Each of storage systems 110 and 140 may be configured to store a port map 113. Port map 113 in any of storage systems 110 and 140 may be stored in the memory of a storage processor that is part of the storage system and/or at any other storage location. As illustrated in FIG. 2, port map 113 may include a plurality of portions 202. Each map portion 202 may correspond to a specific host device (hereinafter “the map portion's corresponding host device”). For each of the plurality of ports in the map portion's host device, a map portion 202 may include a plurality of LUN-specific priority status indicators, wherein each LUN-specific priority status indicator indicates whether the priority status of the port with respect to a given LUN (in one of the storage systems 110 and 140) is “optimized” or “non-optimized”. Port map 113 may be generated by a workload analyzer (WLA) 152, which is executed by management system 150. Additionally, or alternatively, port map 113 may be generated by a storage processor in one of the storage systems 110 and 140, or any other computing device. The present disclosure is not limited to any specific entity generating the port map 113 and/or the port map 113 being stored in one storage location. In one implementation, storage systems 110 and 140 may use the same copy of port map 113 that is stored in the memory of management system 150, as opposed to each of storage systems 110 and 140 having a separate copy of port map 113.

FIG. 3 is a diagram of a port map portion 300, according to aspects of the disclosure. Port map portion 300 may be the same or similar format to any of portions 202 (shown in FIG. 2). As illustrated, port map portion 300 may include a LUN field 312, an array port field 314, and a status field 316. Field 312 may include an indication of a LUN; field 314 may include an indication of a portion in one of the storage systems 110 and 140 (i.e., an array port); and field 316 may include an indication of priority status.

According to one aspect, as described herein LUNs of one or more arrays may be configured in an active-active RDF configuration in which the data from a first LUN is replicated on a second LUN. The paired LUNs may be in the same array or different arrays. For example, and in particular, when disaster recovery is a priority, each of the paired LUNs may be separated by some distance to ensure if a disaster occurs at the location of one of the LUNs, the other LUN may be unaffected by the disaster.

According to one aspect, each of the paired LUNs may be assigned a priority state (e.g., ALUA optimized or non-optimized state) depending on the determination of which LUN is “closer”. As described below, the closer LUN may be given an optimized state, while the other LUN is assigned a non-optimized state. Such states may be reflected in the entries of a port map 113 as previously described herein.

In one aspect, the port map portion illustrates an RDF-duplicate pair in which entry 304 corresponds to a network path to a first LUN (e.g., LUN 1) ending at the entry's storage array port (e.g., port A). The value of the status field 316 identifies the LUN-specific priority status of the entry's 304 corresponding network path, with respect to the LUN identified in field 312 (e.g., LUN 1). Put differently, the value of the status field 316 identifies the LUN-specific priority status of the LUN in the RDF-duplicated pair. Similarly, entry 306 identifies a second LUN in the RDF-duplicated pair (e.g., LUN 5), its terminating port (e.g., PORT H) and the second LUN's current status as a non-optimized state.

When the value of a corresponding LUN's Status Field 316 is set to “optimized”, this may cause the entry's corresponding host device to choose (or prioritize) transmission to the array port identified in the entry (over the other array port of the other LUN identified in the RDF-duplicated pair) to receive I/O requests directed to the volume intended. When the value is set to “non-optimized”, this may cause the entry's corresponding host device to pass over (or ignore) the array port identified in the entry (in favor of the other array port in the other LUN identified in the RDF-duplicated pair) for receiving I/O requests directed to the volume.

Although in the example of FIG. 3, port map 300 is implemented as a table, it will be understood that the present disclosure is not limited to any specific implementation of port map 300. For example, port map 300 may be implemented as a tree structure, a file, a database object, and/or any other suitable type of data structure or a set of data structures. It will be understood that the present disclosure is not limited to any specific implementation of port map 300.

Returning to FIG. 1A, host devices 130A-C may be configured to store, in their respective memories, local port maps 162A-C. Each of the local port maps 162A-C may be a proper subset set of the set of portions 202 that constitutes the port map 113. According to one aspect, the local port maps 162-A-C may be composed by the host port querying each array port for its status. As described herein, if the WLA 152 tells the array to change its ports ALUA states, the array ports will change them and subsequently broadcast a FC management message telling all relevant hosts to re-query the ALUA state. In one example, local port map 162A may be stored in the memory of host device 130A and it may include those portions 202 that correspond to ports in host device 130A; local port map 162B may be stored in the memory of host device 130B and it may include those portions 202 that correspond to ports in host device 130B; and local port map 162C may be stored in the memory of host device 130C and it may include those portions 202 that correspond to ports in host device 130C.

Host device s 130A-C may be configured to execute instances 163A-C of a path selection software. The path selection software may include one or more of a multinetwork path agent, a network driver, and/or any other suitable type of software. According to the present example, instance 163A is executed on host device 130A, instance 163B is executed on host device 130B, and instance 163C is executed on host device 130C. In operation, instance 163A may detect that there is an I/O request directed to a given array in one or both of storage systems 110, 140. Instance 163A may select a source port in host device 130A. Instance 163A may select a network path starting at the selected source port and ending at one of the array ports in storage system 110. And finally, the I/O request may be transmitted over the selected network path. In selecting the network path, instance 163A may give preference to a network path whose LUN-specific priority status with respect to the given LUN is set to “optimized” over network paths whose LUN-specific priority status, with respect to the given LUN, is set to non-optimized. In the context of an active-active RDF pair, instance 163A may select a network path whose LUN-specific priority status is set to “optimized” and ignore the network path whose LUN-specific priority status, with respect to the other LUN of the pair, is set to “non-optimized.” Additionally, or alternatively, in some implementations, instance 163A may select a network path whose LUN-specific priority status, with respect to the given LUN, is set to “non-optimized” only if no network path is available whose LUN-specific priority status with respect to the given LUN is set to “optimized”.

Management system 150 may be configured to execute the workload analyzer (WLA) 152. Although, in the present example, WLA 152 is implemented in software, alternative implementations are possible in which WLA 152 is implemented in hardware or as a combination of software and hardware.

In one example, WLA 152 may be configured to change the respective LUN-specific priority status of a port (e.g., port 1 in host device 130A (or another host device)), with respect to a first LUN that is at least in part hosted by storage system 110. The respective priority status may be changed from “optimized” to “non-optimized”. According to on aspect, the WLA 152 may make the decision to set the ALUA status based on, in part, an IO RT measured at the array from each of the host initiators. While the host IO response time may be unknown, the response time of the array may be a sufficient approximation. In this manner, as described herein, the WLA 152 may determine which array is “closer” (in response time) to the host. According to one aspect, the WLA 152 may further factor other metrics including the array port's busy level, for example. This may allow the WLA 152 to also distribute IO load between ports based on IO load, and not IO response time only.

According to one aspect, once an array port ALUA status changes, the next IO request from the host may fail with a return code from the array indicating that the ALUA status has changed. At that point, the host may query the new status. The change in status (e.g., the return code) may inform host device 130A that the first LUN is no longer a preferred destination for the request. Rather, the second LUN, previously identified as one of an RDF-duplicate pair, may have its priority status set to “optimized.” Accordingly, host device 130A may transmit the request to the newly updated LUN with the optimized status. The first, “non-optimized” LUN may still be selected under exigent circumstances. In most practical applications, however, if the host device is configured correctly, the “non-optimized” destination would be used very rarely, if at all, to receive I/O requests directed to the array.

The change in status field for one or more LUNs may be completed in multiple ways. In one example, the above operation may be performed as follows. WLA 152 may transmit to storage system 110 (i.e., to any given one of the storage processors in storage system 110) an instruction to update port map 133. The instruction may include an identifier of port 1, an identifier of port A, the LUN, as well as an indication of the new value for the priority status of port 1 (i.e., non-optimized). The instruction may be executed by storage system 110. To execute the instruction, storage system 110 (or the given storage processor) may identify portion 202 of port map 113 that corresponds to port 1 of host device 130A. Next, storage system 110 (or the given storage processor) may identify an entry 304 in the identified portion 202 which includes an identifier of port 1 and an identifier of port A. Next, storage system 110 may update the identified entry 304 by overwriting the current value in the priority status field of the identified entry with the value of “non-optimized”. Next, storage system 130 may propagate the update to host device 130A. The propagation may be performed by using the ALUA protocol or in a similar manner. Specifically, storage system 110 (or the given storage processor) may transmit an instruction to host device 130A to synchronize the state of local port map 162A in accordance with the update. The instruction may include an identifier of port 1, an identifier of port A, and an indication of the new priority status (i.e., non-optimized), with respect to the first LUN, of the network path starting at port 1 and ending at port A. Upon receiving the instruction, host device 130A may update local port map 162A to indicate that the priority status of the network path is now “non-optimized”.

As can be readily appreciated, the phrases “changing the priority status of a host port, with respect to a particular LUN and array port” and changing “the priority status of an array port, with respect to a particular LUN and host” are synonymous. In the above example, the priority status of an array port is changed by updating a data structure that is maintained at the storage system. Specifically, in the above example, the priority status of array port A with respect to port 1 and LUN 1 is changed by updating the port map 113.

In the examples above, the LUN-specific priority status of a port is changed from “optimized” to “non-optimized”. However, the same mechanism can be used to change the priority status of a port from “non-optimized” to “optimized”. In the latter case, any instructions that are transmitted to a host device or storage processor may contain “optimized” as the new priority status value, rather than “non-optimized”. Any actions that are ascribed to being performed by “a storage system” may be performed by one or more storage processors or other computing devices that are part of the storage system.

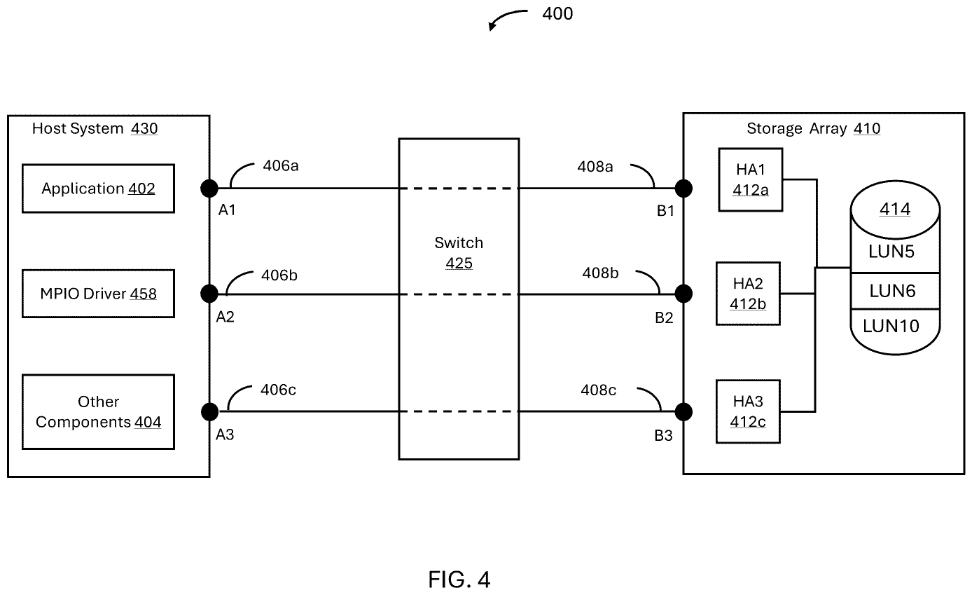

FIG. 4 is a block diagram illustrating an example of a system 400 including a host system 430 communicatively coupled to a storage array 410 via multiple I/O paths, according to aspects of the disclosure. The system 400 may be implemented using one or more components of the system 100 shown in FIG. 1A, for example, one or more storage systems 110, 140 and/or one or more hosts 130A-C, or variations thereof.

The system 400 may include a host system 430, a switch 425 and a storage array system 410. The host system 430 and storage array system 410 may communicate over one or more I/O paths through the switch 425. Elements 406a-406c may denote connections between the host system 430 and the switch 425. Elements 408a-408c may denote connections between the storage array system 410 and the switch 425. Element 414 may represent a physical storage device of the storage array system 414, such as a rotating disk drive, flash-based or other solid state storage device, or the like, where the physical storage physical storage device 414 may be configured to include three or more logical storage units (LSUs) for example LUN5, LUN6 and LUN10. It should be noted that in the illustrative embodiment of FIG. 4, the system 400 may include only a single host system 430, a single physical storage device 414 with three LSUs, a single data storage array system 410, and a single switch 425 for purposes of simplicity to illustrate the concepts, techniques and structures herein. For example, each of the LSUs may be configured to have storage provisioned from multiple different physical storage devices rather than a single physical storage device, and multiple host systems having multiple applications executing thereon may communicate with the data storage system.

It should be appreciated that the descriptions provided in the following paragraphs may refer to particular examples using the switch 425 having a switching fabric for simplicity of illustration. Switch 425 may be a single switch having a switching fabric, or a multi-switch having a multi-switch fabric and the like. Thus, the switch 425 may more generally denote a network having its own connectivity fabric or network fabric where the network may include one or more components providing the connectivity between the host system 430 and storage array system 430.

The host system 430 may be implemented as a server, and may include an application 402, a multi-path I/O (MPIO) driver 458 and other components 404 such as, for example, one or more other device drivers and other code. An I/O request (specifying an I/O operation) from the application 402 may be communicated to the storage array system 410 using the MPIO Driver 458 and one or more other components 404. The application 402 may be a database or other application which issues data operations, such as I/O operations, to the storage array system 410. Each of the I/O operations may be directed to a target device, such as one of the LSUs of physical storage device 414, configured to be accessible to the host system 430 over multiple I/O paths. As such, each of the I/O operations may be forwarded from the application 402 to the storage array system 410 over one of the possible multiple I/O paths.

The MPIO Driver 458 may include functionality to perform any one or more different types of processing such as related to encryption, multi-pathing, mirroring, migration, and the like. For example, the MPIO Driver 458 may include multi-pathing functionality for management and use of multiple I/O paths. For example, the MPIO Driver 458 may perform I/O path selection to select one of the possible multiple I/O paths based on one or more criteria such as load balancing to distribute I/O requests for the target device across available active I/O paths. Load balancing may be performed to provide for better resource utilization and increased performance of the host system, data storage system, and network or other connection infrastructure. Other components 404 of the host system 430 may include one or more other layers of software used in connection with communicating the I/O operation from the host system to the storage array system 410 such as, for example, Fiber Channel (FC) or SCSI drivers, a logical volume manager (LVM), or the like. The other components 404 may include software or other components used when sending an I/O operation from the application 402 to the storage array system 410, where such components may include those invoked in a call stack above and/or below the MPIO Driver 458. For example, application 402 may issue an I/O operation which is communicated via a call stack including a logical volume manager (LVM), the MPIO Driver 458, and an FC or SCSI driver, e.g., as described elsewhere herein in more detail.

The storage array system 410 may include one or more physical storage devices, such as physical storage device 414, where each such physical storage device may be configured to store data of one or more LSUs. Each of the LSUs having data stored on the physical storage device 414 may be configured to be accessible to the host system 430 through one or more I/O paths. For example, all LSUs of physical storage device 414 may be accessible using ports of three front end modules 412a-412c, also denoted respectively as host adapters HA1, HA2 and HA3. The multiple I/O paths allow the application IOs to be routed over multiple I/O paths and, more generally, allow the LSUs of physical storage device 414 to be accessed over multiple I/O paths. In the event that there is a component failure in one of the multiple I/O paths, I/O requests from applications can be routed over other alternate I/O paths unaffected by the component failure. The MPIO Driver 458 may be configured to perform load balancing in connection with I/O path selection, as well as other processing. The MPIO Driver 458 may be aware of, and may monitor, all I/O paths between the host system and the LSUs of the physical storage device 414 in order to determine which of the multiple I/O paths are active or available at a point in time, which of the multiple I/O paths are unavailable for communications, and to use such information to select an I/O path for host system-data storage system communications.

In the example of the system 400, each of the LSUs of the physical storage device 414 may be configured to be accessible through three I/O paths. Each I/O path may be represented by two path endpoints having a first endpoint on the host system 430 and a second endpoint on the storage array system 410. The first endpoint may correspond to a port of a host system component, such as a host bus adapter (HBA) of the host system 430, and the second endpoint may correspond to a port of a data storage system component, such as a port of an HA of the storage array system 410. In the example of the system 400, elements A1, A2 and A3 each denote a port of a host system 430 (e.g., a port of an HBA), and elements B1, B2 and B3 each denote a port of an HA of the storage array system 410. Each of the LSUs of the physical storage device 414 may be accessible over three I/O paths—a first I/O path represented by A1-B1, a second I/O path represented by A2-B2 and a third I/O path represented by A3-B3.

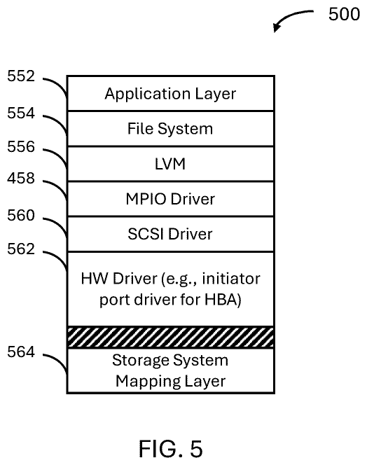

FIG. 5 is a block diagram illustrating an example of a plurality of logical layers 500 of a combination of a host system (e.g., the host system 430 of FIG. 3) and a data storage system (e.g., the storage array system 410) for processing an I/O request, according to embodiments of the invention. Other embodiments of a plurality of logical layers of a combination of a host system and a data storage system for processing an I/O request, for example, variations of logical layers 500, are possible and are intended to fall within the scope of the invention. FIG. 5 provides further detail regarding various software layers that may be used in connection with the MPIO Driver 458 of FIG. 4. The various software layers of 500 may generally form layers included in the runtime I/O stack, such as when an I/O request is issued by an application on a host system to a data storage system. The system includes an application layer 552 which includes application programs executing on the host system. The application layer 552 may refer to storage locations using an associated label or identifier such as a file name or file identifier. Below the application layer 552 is the file system layer 554 and the LVM layer 556 that maps the label or identifier specified by the application layer 552 to an LSU which the host system may perceive as corresponding to a physical storage device address (e.g., the address of one of the disk drives) within the storage system. Below the LVM layer 556 may be the MPIO driver 458 which handles processing of the I/O received from the LVM layer 556. The MPIO Driver 458 may include a base driver and one or more driver extension modules.

Functionality for performing multi-pathing operations may be included in one of the driver extension modules such as a multi-path extension module. As described above, the MP driver may perform processing in connection with multiple I/O path management and selecting one of a plurality of possible I/O paths for use in connection with processing I/O operations and communicating with the data storage system, such as storage array system 410 of FIG. 4. More generally, one or more layers between the application layer 552 and the MPIO Driver 458, for example, the file system 554, may provide for mapping an LSU (such as used in connection with block-based storage), presented by the data storage system to the host system, to another logical data storage entity, such as a file, that may be used by the application layer 552. Below the MPIO Driver 458 may be the SCSI driver 560 and a hardware (HW) driver 562. The SCSI driver 560 may handle processing of a received I/O request from the MPIO Driver 458 such as related to forming a request in accordance with one or more SCSI standards. The hardware driver 562 may be a driver that facilitates communication with hardware on the host system. The hardware driver 560 may be, for example, a driver for an HBA of the host system which sends commands or requests to the data storage system and also receives responses and other communications from the data storage system. It should be appreciated that, in some embodiments, the ordering of the MPIO Driver 458 and SCSI driver 560 may be reversed. That is, in some cases, the MPIO Driver 458 sits below the SCSI driver 560.

In some embodiments, layers 552-564 (including the MPIO driver 458) are implemented on a host (e.g., the host system 430) coupled to a data storage system (e.g., the storage array system 410) that is an intelligent data storage system having its own mapping layer 564 such that the LSU known or exposed to the host system may not directly correspond to a physical storage device such as a disk drive. In such embodiments, the LSU specified by the host system in the I/O operation may be further mapped by the data storage system using its mapping layer 564. For example, an LSU specified by the host system may be mapped by the data storage system to one or more physical drives, and multiple LSUs may be located on the same physical storage device, multiple physical drives, and the like.

The MPIO Driver 458, as well as other components illustrated in FIG. 5, may execute in a kernel mode or another privileged execution mode. In some embodiments using a Unix-based OS, the MPIO Driver 458 may be executed in kernel mode, whereas an application such as represented by application layer 552 may typically execute in user mode, or more generally, a non-privileged execution mode. It should be appreciated that embodiments of the invention may be implemented using any of a variety of different suitable OSs including a Unix-based OS, a Linux-based system, any one of the Microsoft Windows® OSs, or other OSs. Additionally, the host system may provide a virtualized environment and may execute, for example, VMware ESX® or VMware ESXi™ software providing bare-metal embedded hypervisors.

In operation, an application executing at application layer 552 may issue one or more I/O requests specifying I/O operations (e.g., read and write operations) to logical volumes (implemented by the LVM 556) or files (implemented using the file system 554), whereby such I/O requests may be mapped to I/O communications (specifying the I/O operation) directed to LSUs of the data storage system. Such I/O operations from the application layer 552 may be directed to the MPIO Driver 458 after passing through any intervening layers such as, for example, the layers 554 and 556. Communications between an initiator port of the host system and a target port of a data storage system (e.g., target port of an HA) may include those related to I/O operations and other non-I/O commands such as related to host system control operations. I/O operations may include, for example, read and write operations with respect to data stored on an LSU.

In connection with the SCSI standard, an I/O path may be defined between an initiator port of the host system and a target port of the data storage system. An I/O request may be sent from the host system (e.g., from a component thereof such as an HBA), which may be referred to as an initiator, originator or source with respect to the foregoing I/O path. The host system, as the initiator, sends I/O requests along the I/O path to a data storage system (e.g., a particular component thereof such as an HA having a port with a network address), which may be referred to as a target, destination, receiver, or responder. Each physical connection of an I/O path may be between a first endpoint which is a port of the host system (e.g., such as an HBA having ports such as denoted as A1-A3 of FIG. 4) and a second endpoint which is a port of an HA (e.g., such as B1-B3 of FIG. 4) in the data storage system. Through each such I/O path, one or more LSUs may be visible or exposed to the host system initiator through the target port of the data storage system.

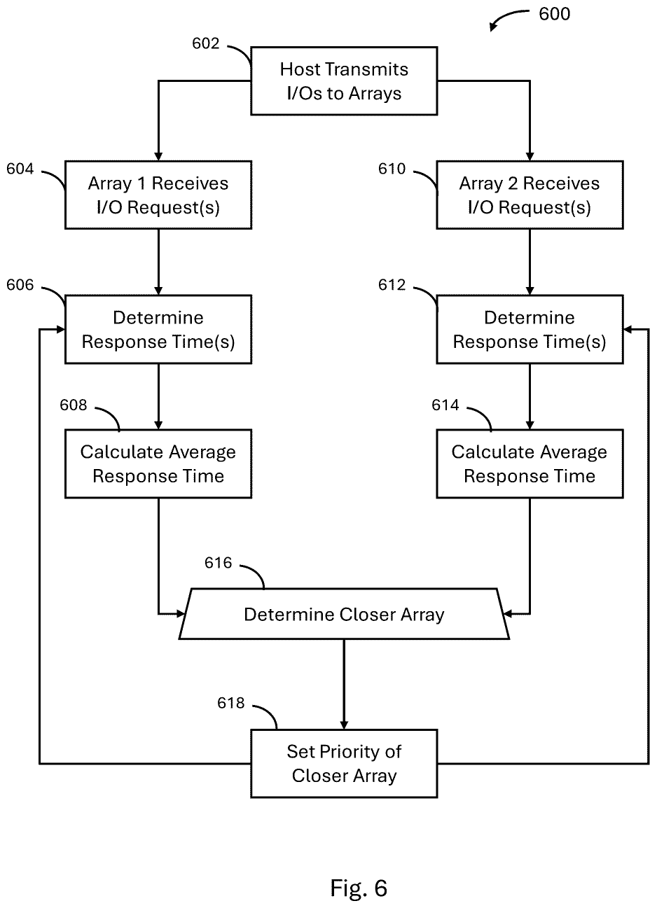

FIG. 6 is a flow diagram of an exemplary method 600 of managing host access in a distributed storage system, according to one or more aspects of the disclosure. In an environment, as described herein, in which a host system may be cross-connected to two arrays in a remote-replication active-active relationship (e.g., two RDF-duplicated arrays), the host system may send I/O operations to both arrays, as the host may not be aware there are multiple arrays. From the host perspective, communication with a storage device having multiple communication paths, occurs without the host being aware that the storage device is located on two different arrays.

As is known in the art, traditional host MPIO drivers support multiple distribution algorithms, including for example, round-robin, load-based, and the like. In a load-based distribution algorithm, a host may monitor the response time of a storage device on the various paths and select the next path on which to send I/O based on a lowest response time. However, load-based is rarely used in MPIO operations. Because the host is unaware of the multiple array setup, it may send I/O operations in round-robin distribution in which some I/O operations will arrive to array1 and others to array2.

Such I/O distributions may work; however, they are not optimal for various reasons. For example, if the host is alternating I/O operations between arrays, it is difficult for an array's pre-fetch operation to determine if there is a sequential operation, making pre-fetch operations not optimal. Further, response times might be different between the arrays (e.g., one may be further away), and hence communicating with the closer (lower RT) will improve performance. Further yet, arrays may have a different load level. It would be optimal if the host sent the I/Os to the less loaded array, however a round-robin distribution does not do so.

According to one aspect of the present disclosure, the SCSI specification provides for ALUA “optimized” and “non-optimized” states. As described herein, one storage array path can be set to ALUA optimized, and the other to ALUA Non-Optimized to control host access to the arrays.

In one aspect, the I/O response time measured by an array may be a sufficient measurement of the I/O response time the initiator (e.g., the host) experiences. The reason the array-measured response time is sufficient is that any delays on the line may be captured in the array response time once the command descriptor block (CDB) arrives, and a response time starts being measured. The only difference in the array-measured IO response time and the initiator-measured response time may be the time it takes the first transaction (e.g., the CDB from the host to the array) and last transaction (e.g., a status indicator from the array to the host) of a whole I/O transaction. That is, the array does not know how long it took the CDB to arrive to it, and the array doesn't know how long it took the status to arrive back to the host. According to one aspect, the difference in the array measured response time and the host measured response time, if it could be determined would be the time it takes the CDB to travel from the host port to the storage array plus the time for the status indicator to travel from the array port to the host port. The host to array CDB time and array to host status indicator time may be considered negligible. Hence, by looking at the array recorded I/O response time, the I/O response time of the initiator (e.g. host) can be determined. Accordingly, according to one aspect, an array has a good measurement of each initiator response time.

Returning now to FIG. 6, as detailed herein, two arrays, for example Array 1 and Array 2, may be part of and/or configured in an active-active RDF configuration in which the data stored on each array is replicated to each other for the purposes of disaster recovery, high availability, data migration, or the like. A host system may transmit I/O operations, shown in block 602, to the arrays unaware of the two-array configuration. As described above, from the host's perspective, the I/Os are transmitted with an intention to arrive at a storage device. It is not aware of the presence of two replicated arrays to which the I/Os may be distributed.

According to one aspect, Array 1 and Array 2 may be cross connected through a fabric network and a fiber channel (FC) switch. Accordingly, the switch may have FDMI information including data detailing which WWNs belong to which HBAs as well as the host name of the installed HBAs. Each of Array 1 and Array 2 may read the FDMI data from the switch informing the respective array of the WWNs of the host from which I/Os may be received.

As shown in blocks 604 and 610, each of Array 1 and Array 2 may receive I/O requests from the WWNs over various paths as detailed in the FDMI data. Each array, according to one aspect, may determine (e.g., record) the response times from each initiator WWN, shown in blocks 606, 612. For example, as shown in blocks 608, 614, Array 1 and Array 2 may average the I/O response times from the host and, according to one aspect, report the average to a management system, like management system 150 shown in FIG. 1. The management system, like each of the arrays, is aware of the FDMI data and may create a connectivity map including the hostname, HBA and initiator port connected to each array port. According to one aspect, the management system may determine, shown in block 616, may determine which array is “closer” to the host. In one aspect, the “closest” array may be the array reporting the lower I/O response time between the two arrays.

As shown in block 618, the management system may assign a priority of the closer array by setting an ALUA “optimized” status on the array reporting the lowest I/O response times among the arrays in the pair. The management station may also set an ALUA “non-optimized” status for the array with the higher I/O response times, designating that array as remote.

If the average response times between the two arrays are the same or are similar (e.g., within 5-10% difference), the management station may balance access between the two arrays using ALUA “optimized” and “non-optimized” states. For example, the management station may set fifty percent of the LUNs on Array 1 to “optimized” for that host and the other fifty percent of LUNs on Array 1 to “non-optimized. Similarly, fifty percent of the LUNs on Array 2 may be set to “optimized” while the other fifty percent is set to “non-optimized.” Such an arrangement may seek to maximize locality benefits if both arrays are experience equal (or substantially equal) response times.

According to one aspect, the method 600 of managing the optimized/non-optimized states of the arrays and their LUNs may be continuous. Accordingly, the arrays may continue measuring the I/O operations response times and reporting them (or their averages) to the management station which may then decide if changes are needed.

According to one or more aspects, if an array with paths set to non-optimized is informed by a witness computer (e.g., a third computer used to decide which array is usable and which is not) that the other array in the pair is down (e.g., dead or otherwise compromised) then the array, or management system, may set appropriate paths to optimized status. In another aspect, if paths set to non-optimized start receiving an inordinate number of I/O requests (e.g., thousands of I/O requests), it may be an indication that the host is sending the I/O requests only (or predominantly) to the non-optimized paths. This may be because the array with paths set to optimized is not performing (e.g., the array is down, dead, has lost connectivity, or is otherwise compromised). In such a circumstance, these paths may be set to optimized.

Referring to FIG. 7, in some embodiments, a computing device 700 may include processor 702, volatile memory 704 (e.g., RAM), non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

As used herein, the term “I/O request” or simply “I/O” may be used to refer to an input or output request. In some embodiments, an I/O request may refer to a data read or write request.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refers to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply.

Similarly, unless explicitly stated otherwise, each numerical value and range should be interpreted as being approximate as if the word “about”, “substantially” or “approximately” preceded the value of the value or range. Further, according to one or more aspects, unless otherwise specified, the terms “about”, “substantially” or “approximately” preceding a value refer to values that are within ±10%. For example, a first amount that is “substantially” the same or equal to a second amount may refer to a first amount that is within ±10% of the second amount.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
providing a first array and a second array in a distributed storage system,
receiving one or more first I/O requests to the first array from a host device;
determining, by the first array, a first response time from the one or more first I/O requests;
receiving one or more second I/O requests to the second array from the host device;
determining, by the second array, a second response time from the one or more second I/O requests; and
assigning a priority to one of the first array and the second array based on a comparison of the first response time and the second response time.

2. The method of claim 1 wherein the first and second arrays are arranged in a remote data facility (RDF) configuration.

3. The method of claim 2 wherein the first and second arrays are arranged in an active-active configuration.

4. The method of claim 1 wherein the priority includes an Asymmetric Logical Unit Access (ALUA) optimized state.

5. The method of claim 1 wherein the priority includes an ALUA non-optimized state.

6. The method of claim 1 wherein the first response time and the second response time each comprise an average response time of the respective one or more first I/O requests and the one or more second I/O requests.

7. The method of claim 1 wherein the comparison comprises selecting a lowest response time from the first response time and the second response time.

8. The method of claim 1 wherein the comparison includes determining the first response time and the second response time are substantially the same and assigning the priority comprises balancing the priorities between the first array and the second array.

9. The method of claim 1 further comprising continuously updating the priority based on subsequent response time measurements by the first array and the second array.

10. The method of claim 1 wherein the priority is updated based on a monitoring device.

11. The method of claim 1 wherein the priority is updated based on an imbalance in received I/O requests to one of the first array and the second array.

12. A system comprising:
a memory; and
at least one processor that is operatively coupled to the memory, the at least one processor being configured to perform the operations of:
providing a first array and a second array in a distributed storage system,
receiving one or more first I/O requests to the first array from a host device;
determining, by the first array, a first response time from the one or more first I/O requests;
receiving one or more second I/O requests to the second array from the host device;
determining, by the second array, a second response time from the one or more second I/O requests; and
assigning a priority to one of the first array and the second array based on a comparison of the first response time and the second response time.

13. The system of claim 12 wherein the first and second arrays are arranged in an active-active remote data facility (RDF) configuration.

14. The system of claim 12 wherein the priority includes an Asymmetric Logical Unit Access (ALUA) optimized state.

15. The system of claim 12 wherein the priority includes an ALUA non-optimized state.

16. The system of claim 12 wherein the first response time and the second response time each comprise an average response time of the respective one or more first I/O requests and the one or more second I/O requests.

17. The system of claim 12 wherein the comparison comprises selecting a lowest response time from the first response time and the second response time.

18. The system of claim 12 wherein the comparison includes determining the first response time and the second response time are substantially the same and assigning the priority comprises balancing the priorities between the first array and the second array.

19. The system of claim 12 further comprising continuously updating the priority based on subsequent response time measurements by the first array and the second array.

20. A non-transitory computer-readable medium storing one or more processor-executable instructions, which when executed by at least one processor cause the at least one processor to perform the operations of:
providing a first array and a second array in a distributed storage system;
receiving one or more first I/O requests to the first array from a host device;
determining, by the first array, a first response time from the one or more first I/O requests;
receiving one or more second I/O requests to the second array from the host device;
determining, by the second array, a second response time from the one or more second I/O requests; and
assigning a priority to one of the first array and the second array based on a comparison of the first response time and the second response time.
